(19) United States
(12) Patent Application Publication
(10) Pub. No.: US 2025/0306837 A1
(43) Pub. Date: Oct. 2, 2025

(54) DISPLAYING CONTENT BASED ON DETECTED FORCE ON A MULTI-DISPLAY DEVICE

(71) Applicant: Motorola Mobility LLC, Chicago, IL (US)

(72) Inventors: Hitalo Cesar Alves, Campinas (BR); Roberto Bresil, Campinas (BR); Anderson Rossanez, Campinas (BR); Rodrigo Barbosa Dias, Campinas (BR); Thiago Resek Fabri dos Anjos, Campinas (BR); Thiago Gomes Marçal Pereira, Campinas (BR)

(73) Assignee: Motorola Mobility LLC, Chicago, IL (US)

(21) Appl. No.: 18/619,595

(22) Filed: Mar. 28, 2024

(51) Int. Cl. G06F 3/14; G06F 3/0488

(52) U.S. Cl. CPC G06F 3/1423; G06F 3/0414; G06F 3/0488

(57) ABSTRACT

In aspects of displaying content based on detected force on a multi-display device, a mobile device includes a first display device attached to a second display device, and the mobile device includes one or more proximity sensors positioned to detect one or more forces applied to the second display device. The mobile device implements a display manager that causes display of digital content on the first display device based at least in part on detecting the one or more forces applied to the second display device.

### BACKGROUND

Mobile devices are capable of performing a multitude of tasks, including facilitating communication, internet browsing, entertainment, productivity, navigation, and capture of digital content. Touch display screens on the mobile devices are integral to performing these tasks and include components that allow users to interact directly with their mobile devices by touching a display of the mobile device rather than using physical buttons or a keyboard. The touch display screens also allow for a high degree of customization and configuration of applications for the mobile device.

### BRIEF DESCRIPTION OF THE DRAWINGS

Implementations of the techniques for displaying content based on detected force on a multi-display device are described with reference to the following Figures. The same numbers may be used throughout to reference like features and components shown in the Figures.

FIG. 1 illustrates an example system for displaying content based on detected force on a multi-display device in accordance with one or more implementations as described herein.

FIGS. 2a and 2b illustrate an example of a mobile device that may be implemented for displaying content based on detected force on a multi-display device in accordance with one or more implementations as described herein.

FIG. 3 illustrates an example sensor system for implementing aspects of displaying content based on detected force on a multi-display device in accordance with one or more implementations as described herein.

FIGS. 4-6 further illustrate examples of displaying content based on detected force on a multi-display device in accordance with one or more implementations as described herein.

FIGS. 7 and 8 illustrate example methods for displaying content based on detected force on a multi-display device in accordance with one or more implementations of the techniques described herein.

FIG. 9 illustrates various components of an example device that may be used to implement the techniques for displaying content based on detected force on a multi-display device as described herein.

### DETAILED DESCRIPTION

Implementations of the techniques for displaying content based on detected force on a multi-display device may be implemented as described herein. A mobile device, such as any type of a wireless device, media device, mobile phone, flip phone, foldable device, client device, tablet, computing, communication, entertainment, gaming, media playback, and/or any other type of computing, consumer, and/or electronic device, or a system of any combination of such devices, may be configured to perform techniques for displaying content based on detected force on a multi-display device as described herein. In one or more implementations, a mobile device includes a display manager, which can be used to implement aspects of the techniques described herein.

Consumers are drawn to mobile devices with large display screens for enjoyable consumption of digital content. On a large display screen, for example, documents are easier to read, photos are viewable in greater detail, and videos are more immersive than on a smaller display screen. Additionally, because these mobile devices generally feature touch screens, the mobile devices with large display screens offer a multitude of possible interactions with the mobile device due to a large surface area to facilitate touch interaction. However, large touch display screens on mobile devices present challenges to users, as it may be difficult to reach some portions of a touch display screen while holding the mobile device in one hand. In an example, a user holding and using a mobile device with one hand may only have a thumb available to interact with the touch display screen because the user's other fingers support the mobile device from behind. Consequently, the user's thumb may not easily reach some areas of the touch display screen, such as the top portion of the touch display screen. This results in the user having to use two hands or reposition the mobile device, which is not possible in some situations, and may lead to a poor user experience.

Conventional systems attempt to address these challenges by re-arranging features of a user interface to make buttons on the touch display screen more accessible. For instance, some systems display selectable buttons or controls more toward a perimeter of the display screen, which are easier to select or touch with a user's thumb. These conventional systems have limitations, however. For example, re-arranging features of a user interface to make selectable buttons and/or controls more accessible can limit useful applications on a mobile device because the selectable buttons and/or controls may be positioned in areas that are easy to reach by the user's thumb, but are not ideal for a particular user interface layout.

Techniques and systems are described for displaying content based on detected force on a multi-display device that overcome these limitations. In aspects of the described techniques, a display system is implemented in a mobile device that includes two or more display devices. The display devices, for instance, may be positioned at different surfaces of the mobile device. Further, the different surfaces may be incorporated together in a single housing or may be incorporated in separate housings attached via a hinge region such that the housings are pivotable relative to one another. The mobile device, for example, represents a foldable device, e.g., a foldable smartphone.

When the mobile device is unfolded to an “open” position, a screen of a front-facing display device (also referred to herein as a display screen) faces a user holding the mobile device, and a screen of a rear-facing display device faces away from the user. The front-facing display device is a touch screen configured to receive a user touch input. In one or more implementations, the rear-facing display device is equipped with proximity sensors that can detect forces applied to the rear-facing display device. In some examples, the proximity sensors cover half of the rear-facing display device, allowing the user to hold the mobile device by a portion without unintentionally touching the proximity sensors.

The display system allows a user to interact with the front-facing display device by touching the rear-facing display device, which is located behind or opposite facing the front-facing display device. Consider an example in which the user is holding the mobile device with one hand. The user's thumb is capable of touching a bottom half of the front-facing display device, but may not reach a virtual button displayed on the top half of the front-facing display device. Instead, the user can actuate the virtual button that is displayed on the front-facing display by touching the rear-facing display device (e.g., the external display when folded) with the user's pointer finger approximately behind where the virtual button is located on the front-facing display device.

To facilitate this, the display system can first detect that the mobile device is in an unfolded position. The display system can then detect a force applied as an input to a proximity sensor of the rear-facing display device. Because the mobile device is in the unfolded position, the display system maps the location of the detected force on the rear-facing display device to a corresponding location on the front-facing display device. For example, a touch is detected at a location on the rear-facing display device and the display system maps the touch to a location on the front-facing display device behind where the touch is detected. Based on the touch, the display system actuates a control or other element of the user interface displayed on the front-facing display device as if the front-facing display device was touched directly.

The display system is capable of translating multiple types of user inputs detected at the rear-facing display device to control features of the front-facing display device, based on any number and/or types of gestures, including touching, swiping, tapping, touching and holding, touching and dragging, or any other gestures. Leveraging these multiple types of inputs allows for displaying content based on detected force on a multi-display device to assist a user with touch interactions with the mobile device for a variety of applications, including gaming, social media, productivity, content creation, media consumption, and/or any other types of device interaction.

Displaying content based on detected force on a multi-display device also overcomes the limitations of conventional systems. For example, detecting a force applied to a rear-facing display device and mapping the force to the front-facing display device alleviates user frustration by allowing greater accessibility to interact with the mobile device. While conventional systems are limited to receiving touch input at a single display device, techniques described here for displaying content based on detected force on a multi-display device, which allows a user to hold the mobile device in one hand and interact with all portions of a user interface, for example, by touching part of the front-facing display device with a thumb and touching part of the rear-facing display device with a different finger. Because touched portions of the rear-facing display device are mapped to the front-facing display device, the combined surface area allows the user to interact with more of a user interface displayed on the mobile device than with conventional systems.

While features and concepts of the described techniques for displaying content based on detected force on a multi-display device is implemented in any number of different devices, systems, environments, and/or configurations, implementations of the techniques for displaying content based on detected force on a multi-display device are described in the context of the following example devices, systems, and methods.

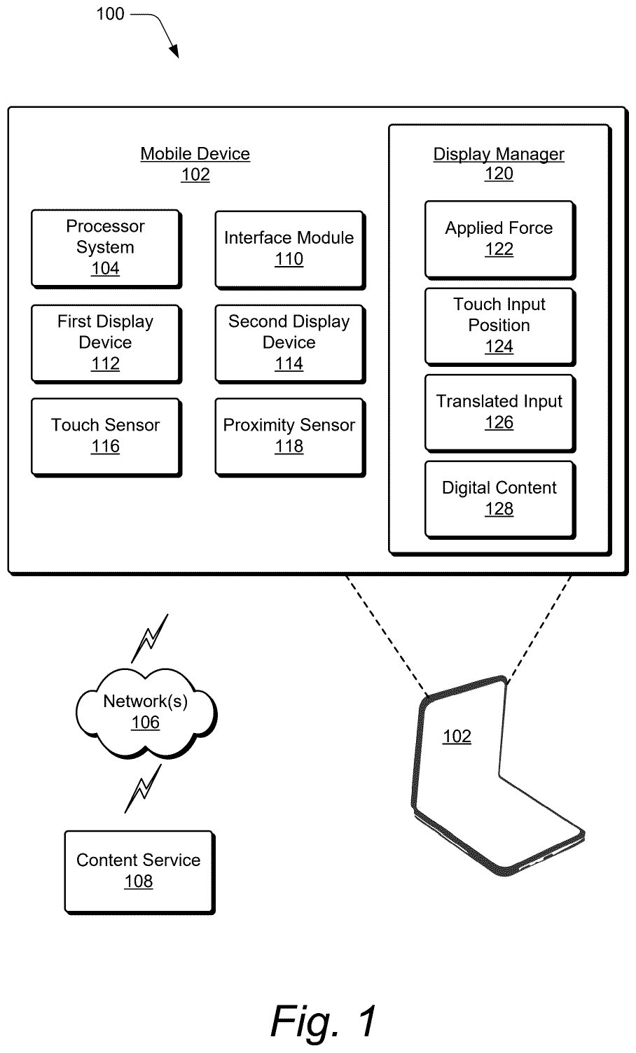

FIG. 1 illustrates an example system 100 for displaying content based on detected force on a multi-display device, as described herein. The system 100 includes a mobile device 102, a processor system 104, and a communication network 106. Examples of the mobile device 102 include at least one of any type of a wireless device, mobile device, mobile phone, foldable device, rollable device, flexible device, flip phone, client device, companion device, tablet, foldable tablet, computing device, communication device, entertainment device, gaming device, media playback device, any other type of computing and/or electronic device.

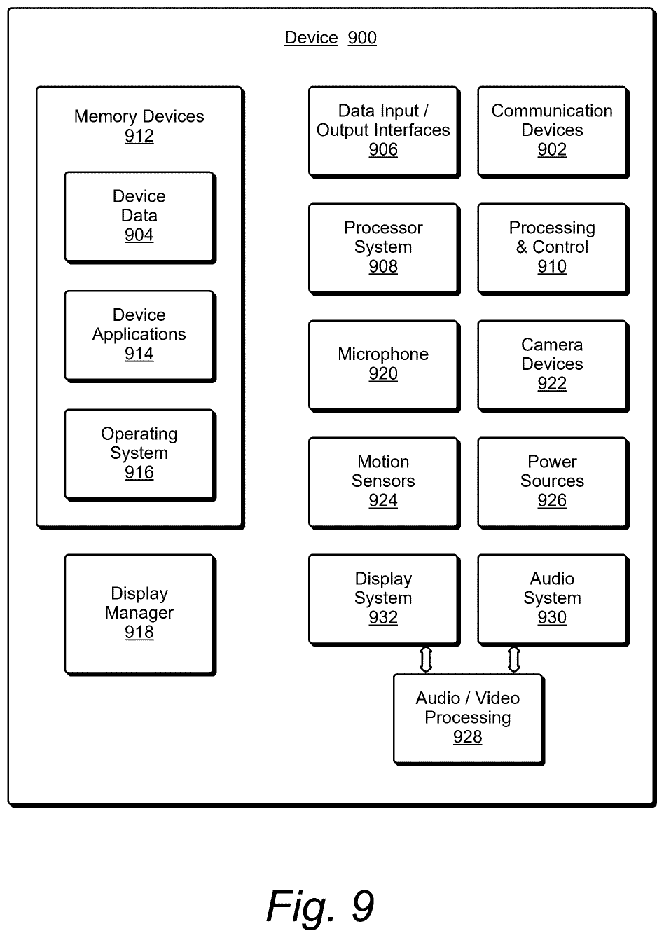

The mobile device 102 can be implemented with various components, such as the processor system 104 and memory, as well as any number and combination of different components as further described with reference to the example device shown in FIG. 9. In implementations, the mobile device 102 includes various radios for wireless communication with other devices. For example, the system and devices can include a Bluetooth (BT) and/or Bluetooth Low Energy (BLE) transceiver, as well as a near field communication (NFC) transceiver. In some cases, the system and devices includes at least one of a WiFi radio, a cellular radio, a global positioning satellite (GPS) radio, or any available type of device communication interface.

In some implementations, the devices, applications, modules, servers, and/or services described herein communicate via the communication network 106, such as for data communication between a content service 108 with the mobile device 102. The communication network 106 includes a wired and/or a wireless network. The communication network 106 is implemented using any type of network topology and/or communication protocol, and is represented or otherwise implemented as a combination of two or more networks, to include IP-based networks, cellular networks, and/or the Internet. The communication network 106 includes mobile operator networks that are managed by a mobile network operator and/or other network operators, such as a communication service provider, mobile phone provider, and/or Internet service provider.

The mobile device 102 includes various functionality that enables the device to implement different aspects of displaying content based on detected force on a multi-display device, as described herein. In one or more examples, an interface module 110 represents functionality (e.g., logic and/or hardware) enabling the mobile device 102 to interconnect and interface with other devices and/or networks, such as the communication network 106. For example, the interface module 110 enables wireless and/or wired connectivity of the mobile device 102.

The mobile device 102 can include and implement various device applications, such as any type of messaging application, email application, video communication application, cellular communication application, music/audio application, gaming application, media application, social platform applications, and/or any other of the many possible types of various device applications. Many of the device applications have an associated application user interface that is generated and displayed for user interaction and viewing, such as on a display device of the mobile device 102. Generally, an application user interface, or any other type of video, image, graphic, and the like is digital image content that is displayable on the display device of the mobile device 102.

The mobile device 102 includes a first display device 112 attached to a second display device 114. For example, the mobile device 102, which may be a foldable device, includes a first surface and a second surface. The first display device 112 is positioned at the first surface of the mobile device 102, and the second display device 114 is positioned at the second surface of the mobile device 102 so that the first display device 112 and the second display device 114 face opposite directions when the mobile device 102 is in an unfolded position. When holding the mobile device 102 with one hand, for instance, a user views the first display device 112, and the user's fingers wrap around the mobile device 102 and may support the mobile device 102 around or on the second display device 114.

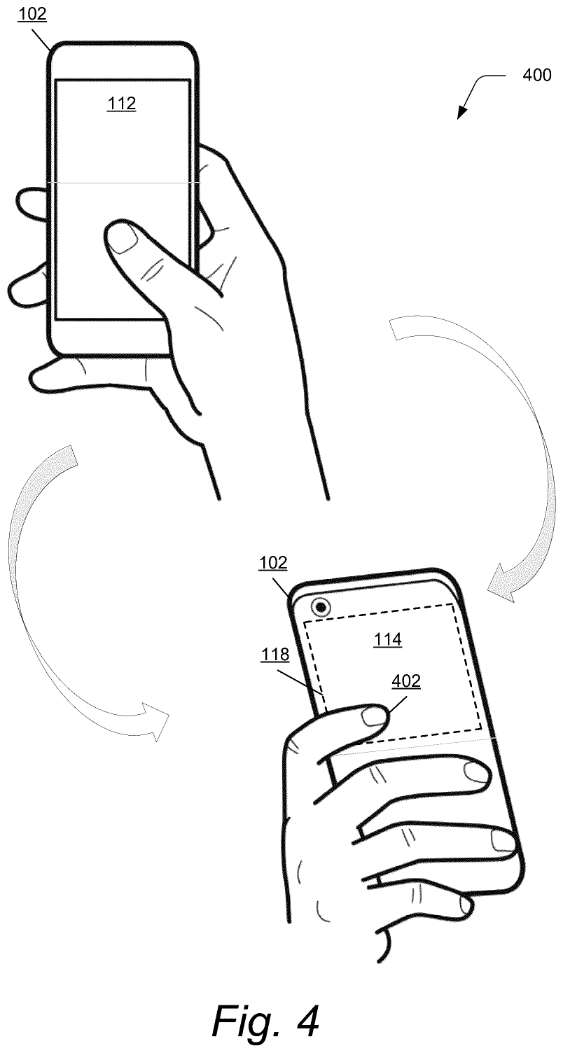

The first display device 112 and the second display device 114 are configured with one or more touch sensors 116, one or more proximity sensors 118, and/or a combination of any other sensors. The one or more touch sensors 116 and the one or more proximity sensors 118, for example, may be incorporated behind screens of the first display device 112 and the second display device 114, respectively. The one or more touch sensors 116 and the one or more proximity sensors 118, for instance, are configured to detect various physical phenomena in relation to the mobile device 102, such as pressure, force, touch, motion, light, image detection and recognition, position, location, sound, temperature, and so forth. In an example, the one or more proximity sensors 118 are configured to use radar technology in some examples to detect positions of fingers at the second display device 114. For example, the one or more proximity sensors 118 emit electromagnetic radar waves, such as radio waves, and detect reflections of the waves off nearby objects, such as the user's finger, which is described in additional detail with respect to FIG. 4. The mobile device 102, however, can include a variety of other sensor types in accordance with the implementations discussed herein.

In the example system 100 for displaying content based on detected force on a multi-display device, the mobile device 102 implements a display manager 120 (e.g., as a device application). As shown in this example, the display manager 120 represents functionality (e.g., logic, software, and/or hardware) enabling aspects of the described techniques for displaying content based on detected force on a multi-display device. The display manager 120 can be implemented as computer instructions stored on computer-readable storage media and can be executed by the processor system 104 of the mobile device 102. Alternatively, or in addition, the display manager 120 can be implemented at least partially in hardware of the device.

In one or more implementations, the display manager 120 includes independent processing, memory, and/or logic components functioning as a computing and/or electronic device integrated with the mobile device 102. Alternatively, or in addition, the display manager 120 can be implemented in software, in hardware, or as a combination of software and hardware components. In this example, the display manager 120 is implemented as a software application or module, such as executable software instructions (e.g., computer-executable instructions) that are executable with the processor system 104 of the mobile device 102 to implement the techniques and features described herein. As a software application or module, the display manager 120 can be stored on computer-readable storage memory (e.g., memory of a device), or in any other suitable memory device or electronic data storage implemented with the controller. Alternatively or in addition, the display manager 120 is implemented in firmware and/or at least partially in computer hardware. For example, at least part of the display manager 120 is executable by a computer processor, and/or at least part of the content manager is implemented in logic circuitry.

In this example system 100, the display manager 120 can detect an applied force 122 at the second display device 114. For example, a user holding the mobile device 102 touches the second display device 114, exerting the applied force 122 at the second display device 114. The display manager 120 leverages the one or more proximity sensors 118 incorporated into the second display device 114 to detect the applied force 122. Additionally, in some examples the display manager 120 may also determine that a finger is in proximity of the second display device 114 before the force is applied and provide a cursor or other indication of a position of the user's finger at the first display device 112, guiding the user where to touch the second display device 114.

The display manager 120 may then determine a touch input position 124 based on the applied force 122. The touch input position 124 indicates a location on the second display device 114 where the surface was touched or is touched. In an example implementation, the one or more proximity sensors 118 may be arranged in a grid on the second display device 114, and each of the one or more proximity sensors 118 is assigned a location on the grid. When a user touches the second display device 114 and exerts a force at a proximity sensor 118, the display manager 120 determines the touch input position 124 by matching the applied force 122 to the proximity sensor 118 to the known location of the proximity sensor 118 on the grid.

Based on the detected force, the display manager 120 can generate a translated input 126. Based on the location of the applied force 122, the display manager 120 maps the applied force 122 to a mapped location 502 of a translated input 126 on the first display device 112. The display manager 120 may apply a variety of techniques to map the applied force 122 to the mapped location 502 of the translated input 126. In one example, the display manager 120 may determine coordinates of the applied force 122 on a plane corresponding to the second display device 114. The display manager 120 then flips, scales, or otherwise translates the coordinates to a mirrored position on a plane, area, or region corresponding to the first display device 112.

The display manager 120 then causes presentation of digital content 128, or a display change of the digital content 128, on the first display device 112 based on the translated input 126. For example, the digital content 128 is presented on the first display device 112. The digital content 128, for instance, may result from execution of an application at the mobile device 102 or presentation of content received from the content service 108 via the communication network 106. The digital content 128 may facilitate receiving a user input or to facilitate any other kind of user interaction with the digital content 128 using the first display device 112 or the second display device 114. In an example, the digital content includes an option to select a control in a video game. The control may be selected by touching either the first display device 112 or the second display device 114. Because the user is holding the mobile device 102 in one hand and cannot easily reach the first display device 112 with a finger, the user touches a location at the second display device 114 directly behind the location of the first display device 112 depicting the control.

The display manager 120 receives input from the sensors, including the applied force 122 where the user touched the second display device 114 and determines a touch input position 124 at the second display device 114. The display manager 120 may then generate a translated input 126 to the first display device 112 indicating the location of the first display device 112 that corresponds to the touch input position 124 on the second display device 114. Because the location of the translated input 126 corresponds to the control in the video game presented on the first display device 112, the display manager 120 causes presentation of digital content 128 on the first display device 112, which includes actuation of the control.

In other examples, the digital content 128 may include any response to the translated input 126 at the first display device 112. For instance, the digital content 128 may include the same content or response resulting from a detected touch input directly at a location of the first display device 112 or the applied force 122 to the touch input position 124 of the second display device 114 corresponding to the location of the first display device 112.

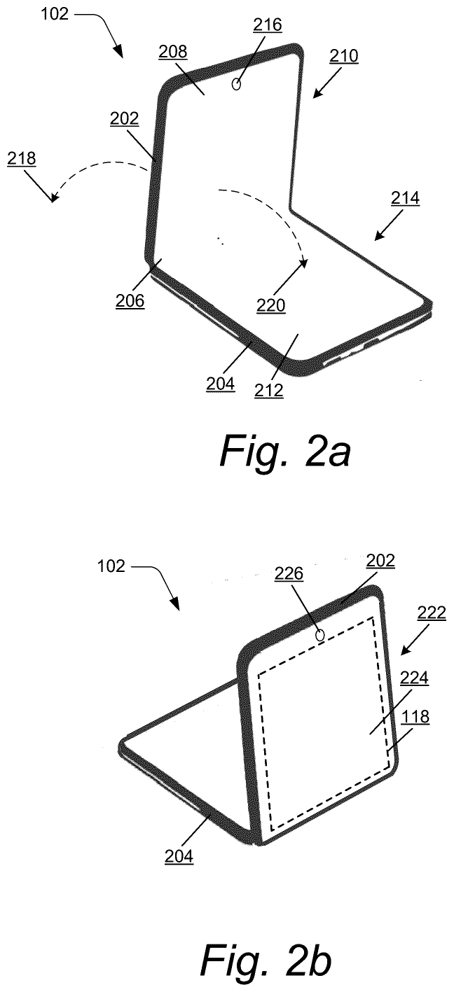

FIG. 2a illustrates example 200a of a mobile device 102 for displaying content based on detected force on a multi-display device, as described herein. The view depicted in FIG. 2a, for instance, represents an interior, front-facing view of the mobile device 102. The mobile device 102 includes a first housing 202 attached to a second housing 204 via a hinge region 206. The first housing 202 and/or the second housing 204, for instance, are pivotable about the hinge region 206 to assume a variety of different angular orientations relative to one another. The first housing 202 includes an upper display device 208 positioned on an upper front-facing surface 210 of the first housing 202, and the second housing 204 includes a lower display device 212 positioned on a lower front-facing surface 214 of the second housing 204. The mobile device 102 further includes a front-facing camera 216 positioned on the upper display device 208 of the first housing 202. The front-facing camera 216 is positionable in various ways, such as within the perimeter of the upper display device 208 and/or underneath the upper display device 208. Alternatively or additionally, the front-facing camera 216 is positionable adjacent the upper display device 208.

In the depicted orientation, the mobile device 102 is in a partially open position with the first housing 202 pivoted away from the second housing 204. The first housing 202 is further pivotable about the hinge region 206 away from the second housing 204 to a fully open position 218. In the fully open position 218, for instance, the first housing 202 is substantially coplanar with the second housing 204. For example, in the fully open position 218 the upper display device 208 and the lower display device 212 are coplanar and form a single integrated display surface, which is herein referred to as the first display device 112. The first housing 202 is also pivotable about the hinge region 206 to a closed position 220 where the upper display device 208 is positioned against the lower display device 212. In at least one implementation a hinge sensor is able to detect an orientation of the mobile device 102, e.g., based on an orientation of the first housing 202 relative to the second housing 204. The hinge sensor, for instance, can detect an angle of the first housing 202 relative to the second housing 204, and/or an amount of pivoting motion and/or rotation of the hinge region 206. Detecting the orientation of the mobile device 102 can be utilized for various purposes, such as for determining how to present the digital content 128 and/or what digital content 128 content to be present on the different display devices of the mobile device 102. Although the mobile device 102 is depicted and described as a foldable mobile device, the mobile device 102 may not be foldable, yet may still be configured with a first display device 112 on one side of the mobile device 102 and a second display device 114 on an opposite facing side of the mobile device 102.

FIG. 2b illustrates example 200b of an additional example of the mobile device 102 for displaying content based on detected force on a multi-display device, as described herein. The view depicted in FIG. 2b, for instance, represents a rear-facing view of the mobile device 102, such as in the partially open position. In this view, a rear surface 222 of the first housing 202 is illustrated, and the rear surface 222 includes a rear-facing display device 224, which is also herein referred to as the second display device 114. Further, the rear surface 222 includes a rear-facing camera 226 positioned on the rear surface 222 of the first housing 202. The rear-facing camera 226 is positionable in various ways, such as within the perimeter of the rear-facing display device 224 and/or underneath the rear-facing display device 224. Alternatively or additionally, the rear-facing camera 226 is positionable adjacent the rear-facing display device 224.

The rear-facing display device 224 includes one or more proximity sensors 118. For instance, the one or more proximity sensors 118 may be incorporated behind or in any other relation to the rear-facing display device 224. For example, Organic Light-Emitting Diode (“OLED”) panels can be made partially transparent or can be designed to have areas where pixels can be controlled to become transparent, allowing infrared or other types of signals from the one or more proximity sensors 118 to pass through. In other embodiments, the one or more proximity sensor 118 are incorporated to a side of the rear-facing display device 224 or surrounding a perimeter of the rear-facing display device 224.

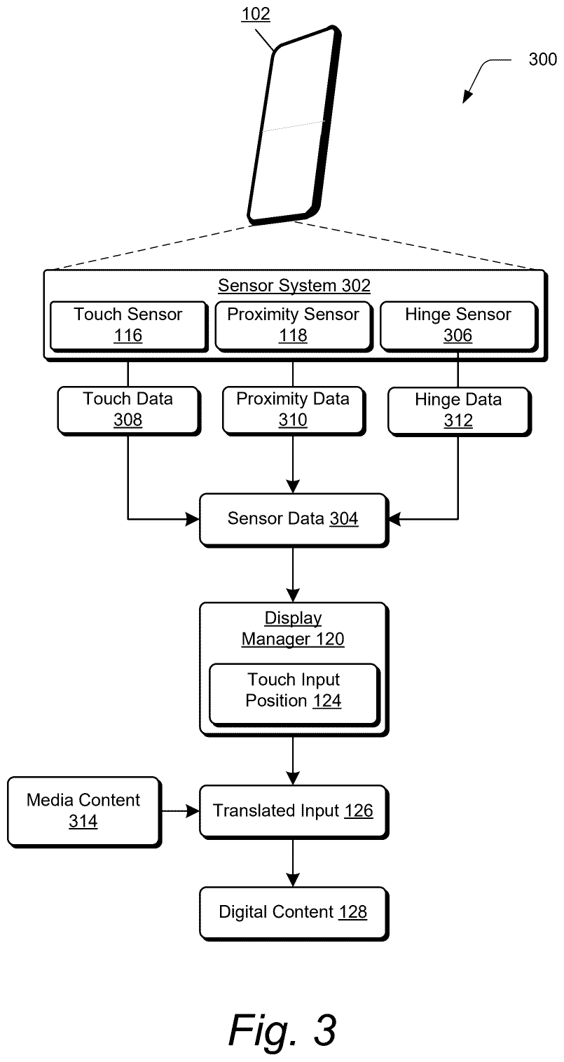

FIG. 3 illustrates example 300 of a sensor system implemented in the mobile device for displaying content based on detected force on a multi-display device, as described herein. In this example 300, the mobile device 102 is implemented with a sensor system 302 capable of collecting sensor data 304 to support displaying content based on detected force on a multi-display device. The sensor system 302 may include one or more touch sensors 116, one or more proximity sensors 118, a hinge sensor 306, or any other type of sensor.

The one or more touch sensors 116 are capable of collecting touch data 308. To collect touch data 308, the one or more touch sensors 116 detect changes in an electrical signal when a conductive object, such as a finger, interacts with the one or more touch sensors 116. Capacitive touch sensors, for example, measure changes in capacitance, which is the ability of an object to store an electrical charge. The capacitive touch sensors often consist of a grid of conductive materials, such as indium tin oxide, arranged in rows and columns. Each intersection in the grid forms a capacitor, and before any touch occurs, the one or more touch sensors 116 establishes a baseline capacitance for each point on the grid. When a conductive object touches the surface, it disrupts the electric field between the grid points, altering the capacitance at the touch point. A controller of the one or more touch sensors 116 detects these changes, determines the touch location based on affected rows and columns, and then sends a signal indicating the touch event.

The one or more touch sensors 116 may alternatively include a resistive touch sensor, which is made up of two transparent, conductive layers separated by a small gap. When pressure is applied to a top layer of the conductive layers, contact is made with a bottom layer, changing the electrical current. The controller sends a voltage across one layer and measures the voltage drop at the point of contact on the other layer. From this voltage drop, the controller calculates X and Y coordinates of the touch point, which are then sent to the device's controller for processing.

The one or more touch sensors 116 may alternatively include a surface acoustic wave (SAW) touch sensor, which uses ultrasonic waves emitted across a screen's surface by transducers placed on its edges. When the screen is touched, some of these waves are absorbed, and the transducers detect this change. The controller analyzes the pattern of wave changes to determine the touch location, which is then relayed to the display manager 120.

The one or more proximity sensors 118 are capable of collecting proximity data 310. In an example, the proximity sensor 118 leverage radar to detect the presence of objects or gestures without physical contact. Radar-based proximity sensors emit radio waves and then measure the time it takes for the waves to bounce back after hitting an object, which is also known as Time-of-Flight (ToF) sensing. The radar sensor of the one or more proximity sensors 118 emits radio frequency (RF) signals, often in the form of short pulses. These signals travel outward from the sensor, bounce off nearby objects, and then return to the sensor. The one or more proximity sensors 118 measure the time it takes for the signal to make this round trip, known as the time of flight, or the time it takes for the signal to travel to the object and back. By calculating the time it takes for the signal to return, the one or more proximity sensors 118 equipped with radar determine the distance between the device and the object.

Additionally or alternatively, the one or more proximity sensors 118 may utilize infrared (IR) technology, which allows the device to detect the presence of nearby objects without physical contact. Infrared proximity sensors work by emitting infrared light and then measuring the reflection of that light off nearby objects. The one or more proximity sensors 118 emit an infrared beam, which bounces back to the sensor when it encounters an obstacle or when an object comes within a certain range. This change in the reflected light is then detected by the one or more proximity sensors 118, indicating the presence or absence of an object in close proximity.

The hinge sensor 306 is capable of collecting hinge data 312. For instance, the hinge sensor 306 is incorporated into a hinge of the mobile device 102 as described with relation to FIG. 2a to detect an orientation of the mobile device 102, e.g., based on an orientation of the first housing relative to the second housing. The hinge sensor, for example, can detect an angle of the first housing relative to the second housing, and/or an amount of pivoting motion and/or rotation of the hinge region. In some examples, the display manager 120 may first determine that the mobile device 102 is in an unfolded position based on the hinge data 312 from the hinge sensor 306 before detecting the applied force 122 at the second display device 114. This prevents unintentional actuation of controls by a user accidentally touching the one or more touch sensors 116 of the second display device 114 when the mobile device 102 is in a folded position, for example, when the mobile device 102 is stored in a pocket.

The display manager 120 receives the sensor data 304, including the touch data 308, the proximity data 310, and/or the hinge data 312. Using the proximity data 310, for instance, the display manager 120 determines a touch input position 124. The display manager 120 identifies a location on the second display device 114 where an applied force 122 is detected by the one or more proximity sensors 118. For example, the proximity data 310 may indicate a current position of a finger or stylus in proximity to the second display device 114. In other examples, the proximity data 310 may indicate a location of a touch on the second display device 114.

The display manager 120 generates a translated input 126 based on the touch input position 124. To do this, the display manager 120 maps the touch input position 124 to a location of the first display device 112 based on a predetermined criteria. In some examples, for instance, locations on the second display device 114 may correspond to locations on the first display device 112 that are directly behind the second display device 114. In some implementations, the display manager 120 mirrors coordinate points of the one or more proximity sensors 118 on the second display device 114 to locations on the first display device 112. Additionally or alternatively, the display manager 120 scales locations of inputs at the touch input position 124 to correspond to the first display device 112.

Based on the translated input 126, the display manager 120 generates digital content 128. In some examples, the display manager 120 additionally receives media content 314 that is used to generate the digital content 128. For example, the digital content 128 may include a response to a prompt presented by the media content 314. The applied force 122 indicates a location on the first display device 112 that the user wishes to actuate in interaction with the media content 314. For example, interactions with the media content 314 displayed on the first display device 112 may include a swipe input, a tap input, a touch input, a hold input, a drag input, and/or any other type of input at the second display device 114, which is translated to actuate a control on the first display device 112 in the form of the digital content 128.

FIG. 4 illustrates example 400 of displaying content based on detected force on a multi-display device, as described herein. In this example 400, the display manager 120 detects a finger position 402 of a user finger in proximity of the second display device 114.

In one or more implementations, a user holds the mobile device 102 as described with respect to FIG. 4 with one hand. For instance, the mobile device 102 includes a first display device 112 and a second display device 114 that are positioned at different surfaces of the mobile device 102. The mobile device 102 includes a hinge, allowing the mobile device 102 to be configured in a folded position or an unfolded position. In the folded position, the first display device 112 is folded inward and not visible by a user holding the mobile device 102. In the unfolded position, the first display device 112 is open and visible by the user holding the mobile device 102, while the second display device 114 is behind the first display device 112 and faces away from the user. The user's thumb may rest on the first display device 112, and the user's fingers support the back of the mobile device 102, on or near the second display device 114.

The display manager 120 detects that the mobile device 102 is in an unfolded position. For example, the display manager 120 receives hinge data 312 from a hinge sensor 306 incorporated at the hinge of the mobile device 102 that determines whether the hinge is open or closed. Based on detecting that the mobile device 102 is in the unfolded position, for instance, the display manager 120 monitors positions of fingers, a stylus, or other objects at the second display device 114 using one or more proximity sensors 118 at the second display device 114.

In some examples, in addition to detecting that the mobile device 102 is in an unfolded position, the display manager 120 may additionally detect whether the mobile device 102 is in a locked mode, which prevents the display manager 120 from monitoring the positions of the fingers at the second display device 114 using the one or more proximity sensors 118 at the second display device 114. For example, the mobile device may be configured in the locked mode based on user input to one or more software or hardware controls. For instance, the mobile device 102 may include a physical button or switch, that configures the mobile device 102 in the locked mode when actuated to prevent the display manager 120 from monitoring the positions of the fingers at the second display device 114 using the one or more proximity sensors 118 at the second display device 114.

The one or more proximity sensors 118 may be incorporated behind or into the second display device 114. The one or more proximity sensors 118 use radar technology in some examples to detect positions of fingers at the second display device 114. For example, the one or more proximity sensors 118 emit electromagnetic waves, such as radio waves, and detect reflections of the waves off nearby objects, such as the user's finger. To do this, the proximity sensor 118 emits electromagnetic waves, typically in the radio frequency (RF) range. These waves propagate outward from the proximity sensor 118. When these waves encounter objects within their detection range, such as a user's finger, they are partially reflected back towards the proximity sensor 118. The amount of reflection depends on various factors, including the size, shape, and composition of the object. The proximity sensor 118 detects the reflections of the emitted waves. By measuring properties such as the time it takes for the waves to return (time-of-flight), changes in frequency (Doppler effect), or changes in phase, the proximity sensor 118 can determine the distance, speed, and sometimes even the direction of nearby objects. The proximity sensor 118 processes the received signals to extract relevant information about the detected objects, which may involve filtering out noise, analyzing the waveform characteristics, and applying algorithms to determine the proximity and other parameters of the objects. Based on the analysis of the reflected waves, the proximity sensor 118 generates an output signal indicating the presence, distance, and sometimes the velocity or motion of nearby objects, which is received by the display manager 120.

Based on the output signal, the display manager 120 detects a finger position 402 of the user's finger in proximity of the second display device 114 using the proximity sensor 118. For example, the display manager 120 may detect the finger position 402 before a force is applied to the second display device 114. This may occur when the user hovers a finger over the second display device 114 but has not yet touched or applied a force to the second display device 114.

In some examples, the finger position 402 is mapped to the first display device 112 to display a cursor or other indicator of a location of the finger position 402 at the second display device 114 before a force is applied at the second display device 114. This provides the user with an indication of where the user's finger is positioned behind the first display device 112 so that the user may accurately apply a force to the second display device 114 at an intended target location to actuate a control displayed on the user interface of the first display device 112.

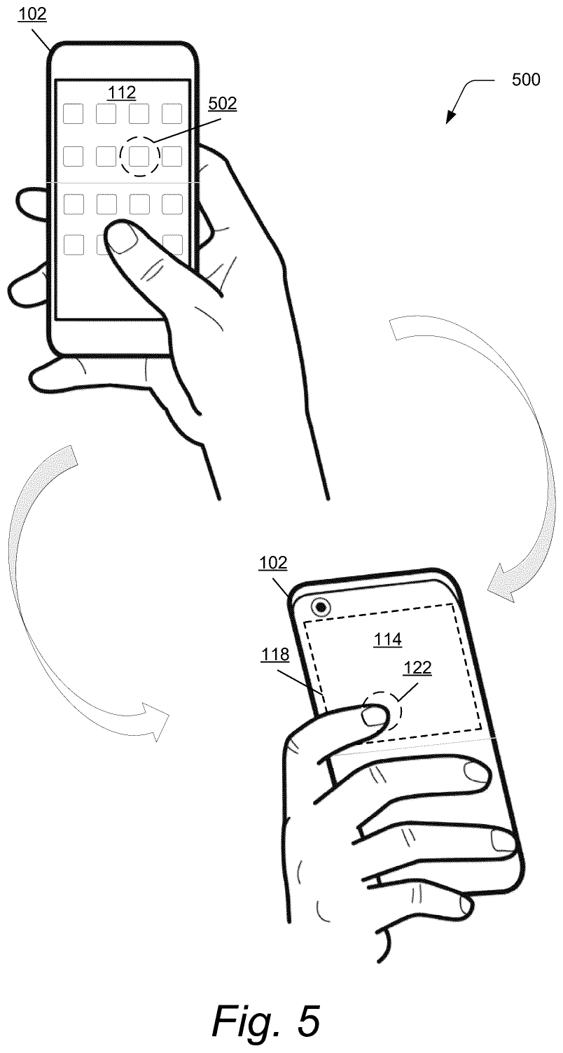

FIG. 5 illustrates example 500 of displaying content based on detected force on a multi-display device, as described herein. In this example 500, the display manager 120 detects an applied force 122 at the second display device 114. This example 500 is a continuation of the example 400 described with respect to FIG. 4. In one or more implementations, the display manager 120 monitors for applied forces at the proximity sensor 118. In some examples, a touch sensor is additionally implemented with the proximity sensor 118 at the second display device 114 to detect forces applied to the second display device 114.

After detecting the applied force 122, the display manager 120 determines a location on the second display device 114 at which the applied force 122 occurs. Based on the location of the applied force 122, the display manager 120 maps the applied force 122 to a mapped location 502 on the first display device 112. The display manager 120 may apply a variety of techniques to map the applied force 122 to the mapped location 502. In one example, the display manager 120 may determine coordinates of the applied force 122 on a plane corresponding to the second display device 114. The display manager 120 then flips or otherwise translates the coordinates to a mirrored position on a plane corresponding to the first display device 112. Additionally or alternatively, the display manager 120 translates the coordinates to scale a size of an area of the applied force 122 on the second display device 114 to an area of the first display device 112. In another example, real-time mapping data collected by the proximity sensor 118 is used to predict a location of the applied force 122.

In this example 500, the user is holding the mobile device 102, which displays a selection of applications displayed in a grid in the user interface of the first display device 112. Because the user is holding the mobile device 102 with one hand, the user's thumb is located at the front of the mobile device 102, with access to touching a lower portion of the first display device 112, and the user's other fingers are supporting the mobile device 102 and have access to touching a back portion of the mobile device 102. The user intends on touching an application located at the upper portion of the first display device 112, but the user's thumb cannot reach the application. Instead of shifting the mobile device 102 in the user's hand or using a different hand to touch the application, the user conveniently uses a finger at the back of the mobile device 102 to touch a portion of the second display device 114 directly behind the application on the first display device 112. The display manager 120 detects the applied force 122 at the second display device 114 using the proximity sensor 118, where the applied force 122 is applied by the user's finger while holding the mobile device 102. The display manager 120 then maps the applied force 122 to the first display device 112. The mapped location 502 corresponds to the application the user intended to touch, and in response the display manager 120 causes actuation of the application in the user interface of the first display device 112.

In this example, the mapped location 502 is directly behind the location of the applied force 122. In other examples, however, the mapped location 502 may be a translated, mirrored, or shifted location from the location of the applied force 122. For example, the mapped location 502 may be shifted on the first display device 112 based on a predetermined location specified by an application on the mobile device 102 or based on user input.

Although this example 500 describes receiving the applied force 122 at the second display device 114, in other examples an applied force 122 is detected at the first display device 112 and mapped to the second display device 114. For example, the user intends to give a demonstration or show digital content to person located facing the user, with the mobile device 102 positioned between the person and the user. Because the person is facing the second display device 114, the user may interact with the first display device 112 to display a version of content from the first display device 112 at the second display device 114 for the person to view in real time.

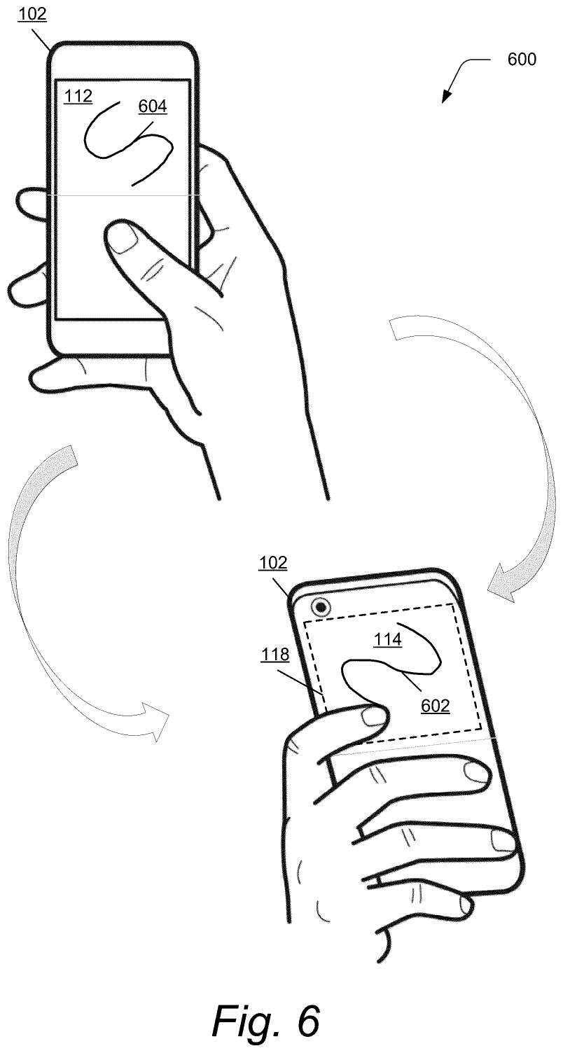

FIG. 6 illustrates example 600 of displaying content based on detected force on a multi-display device, as described herein. In this example 600, the display manager 120 maps a dragged applied force detected at the second display device 114 to the first display device 112. This example 600 is a continuation of the example 400 described with respect to FIG. 4. In one or more implementations, the display manager 120 monitors for applied forces at the proximity sensor 118. In some examples, a touch sensor is additionally implemented with the proximity sensor 118 at the second display device 114 to detect forces applied to the second display device 114.

After detecting the applied force 122, the display manager 120 determines a type of force applied. For example, the applied force 122 may be a swipe input, a tap input, a touch input, a hold input, a drag input, or any other type of applied force 122. If the applied force 122 involves multiple locations on the second display device 114, such as the drag or swipe, the display manager 120 determines a pathway 602 of the applied force 122. To determine the pathway 602 of the applied force 122, the display manager 120 determines a starting location on the second display device 114 at which the applied force 122 occurs and then tracks the pathway 602 of the applied force 122. In some examples, this may involve collecting incremental datapoints tracing the applied force 122 from the user's finger across the second display device 114.

Based on the pathway 602 of the applied force 122, the display manager 120 maps the applied force 122 to a mapped pathway 604 on the first display device 112. The display manager 120 may apply a variety of techniques to map the applied force 122 to the mapped pathway 604. In one example, the display manager 120 may determine coordinates of the applied force 122 on a plane corresponding to the second display device 114. The display manager 120 then flips or otherwise translates the coordinates to a plane or an area corresponding to the first display device 112. In another example, real-time mapping data collected by the proximity sensor 118 is used to predict a location of the applied force 122.

In this example 600, the user is holding the mobile device 102, which displays a user interface of a drawing application on the first display device 112. Because the user is holding the mobile device 102 with one hand, the user's thumb is located at the front of the mobile device 102, with access to touching a lower portion of the first display device 112, and the user's other fingers are supporting the mobile device 102 and have access to touching a back portion of the mobile device 102. The user intends on drawing a curved line on the upper portion of the first display device 112, but the user's thumb cannot reach the upper portion. Instead of shifting the mobile device 102 in the user's hand or using a different hand to draw the curved line, the user conveniently uses a finger at the back of the mobile device 102 to draw the curved line on the second display device 114 directly behind the displayed application on the first display device 112.

The display manager 120 detects the applied force 122 at the second display device 114 using the proximity sensor 118, and determines a pathway 602 where the applied force 122 is applied by the user's finger while holding the mobile device 102. The display manager 120 then maps a mapped pathway 604 to the first display device 112. The mapped pathway 604 corresponds to the curved line the user intended to draw, which is displayed in the user interface of the first display device 112. Although this example describes displaying content based on a detected force applied to draw a curved line, these techniques may be applied to any situation involving tracing a pathway 602, including toggling controls, playing games, editing images, zooming a camera, controlling video playback, or any other application feature.

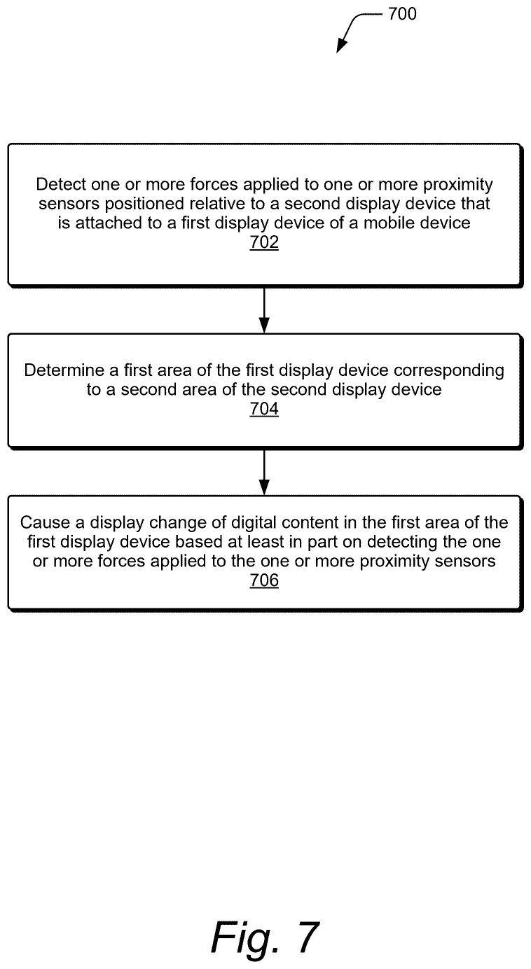

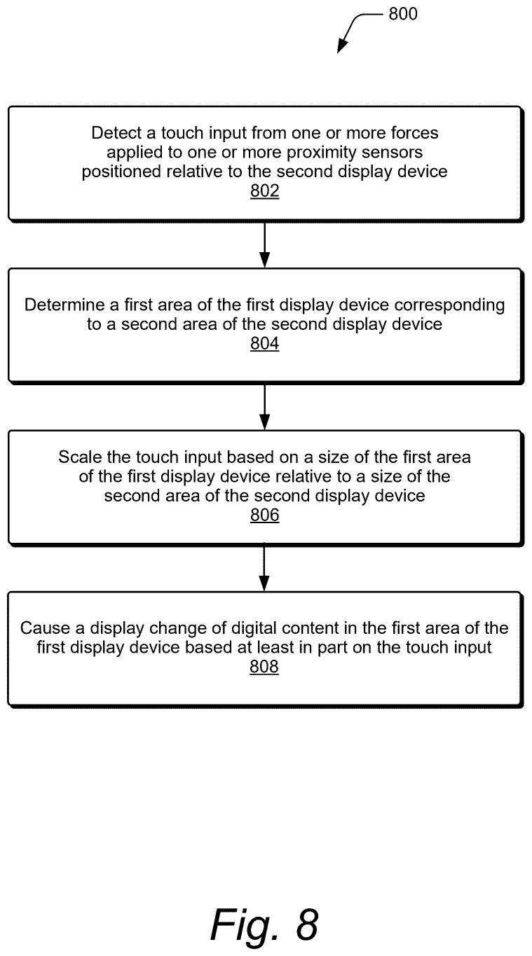

Example methods 700 and 800 are described with reference to respective FIGS. 7 and 8 in accordance with one or more implementations of displaying content based on detected force on a multi-display device, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 7 illustrates example method(s) 700 for displaying content based on detected force on a multi-display device. The order in which the method is described is not intended to be construed as a limitation, and any number or combination of the described method operations may be performed in any order to perform a method, or an alternate method.

At 702, one or more forces are detected as applied to one or more proximity sensors positioned relative to a second display device that is attached to a first display device of a mobile device. For example, the display manager 120 detects one or more forces applied to one or more proximity sensors 118 positioned relative to a second display device 114 attached to a first display device 112 of a mobile device 102. In some implementations, the display manager 120 detects a touch input position 124 of an applied force 122 on the second display device 114. For example, the one or more forces applied to the one or more proximity sensors 118 include one or more of a swipe input, a tap input, a touch input, a hold input, or a drag input. In some implementations, the display manager 120 detects a finger positioned proximate the second display device 114.

At 704, a first area of the first display device corresponding to a second area of the second display device is determined. For example, the display manager 120 determines a first area of the first display device 112 corresponding to a second area of the second display device 114. In some implementations, the display manager 120 maps the touch input position 124 in the second area of the second display device 114 to the first area of first display device 112.

At 706, a change of digital content in the first area of the first display device is caused based at least in part on detecting the one or more forces applied to the one or more proximity sensors. For example, the display manager 120 causes a change to digital content in the first area of the first display device 112 based at least in part on detecting the one or more forces applied to the one or more proximity sensors 118. In some implementations, the display change of the digital content in the first display device 112 is based on a mirrored translation of the touch input position 124 on the second display device 114. Additionally or alternatively, the display change of the digital content is in response to detecting that the mobile device 102 is unfolded, wherein the second display device 114 is positioned opposite facing of the first display device 112.

FIG. 8 illustrates example method(s) 800 for displaying content based on detected force on a multi-display device. The order in which the method is described is not intended to be construed as a limitation, and any number or combination of the described method operations may be performed in any order to perform a method, or an alternate method.

At 802, a touch input is detected from one or more forces applied to one or more proximity sensors positioned relative to the second display device. For example, the display manager 120 detects a touch input from one or more forces applied to one or more proximity sensors 118 positioned relative to the second display device 114. In some implementations, the one or more forces applied to the one or more proximity sensors 118 include one or more of a swipe input, a tap input, a hold input, or a drag input.

At 804, a first area of the first display device corresponding to a second area of the second display device is determined. For example, the display manager 120 determines a first area of the first display device 112 corresponding to a second area of the second display device 114. In some implementations, the display manager 120 maps the touch input to the first display device 112.

At 806, the touch input is scaled based on a size of the first area of the first display device and a size of the second area of the second display device. For example, the display manager 120 scales the touch input based on a size of the first area of the first display device 112 and a size of the second area of the second display device 114.

At 808, a display change of digital content is caused in the first area of the first display device based at least in part on the touch input. For example, the display manager 120 causes a display change of digital content in the first area of the first display device 112 based at least in part on the touch input. In some implementations, the display change of the digital content in the first display device 112 is based on a mirrored translation of the touch input position on the second display device 114. For example, the display manager 120 causes the display change of the digital content in the first display device 112 in response to detecting that the mobile device 102 is unfolded, wherein the second display device 114 is positioned opposite facing of the first display device 112.

FIG. 9 illustrates various components of an example device 900, which can implement aspects of the techniques and features for displaying content based on detected force on a multi-display device, as described herein. The example device 900 may be implemented as any of the devices described with reference to the previous FIGS. 1-8, such as any type of a wireless device, mobile device, mobile phone, flip phone, client device, companion device, display device, tablet, computing, communication, entertainment, gaming, media playback, and/or any other type of computing, consumer, and/or electronic device. For example, the mobile device 102 described with reference to FIGS. 1-8 may be implemented as the example device 900.

The example device 900 can include various, different communication devices 902 that enable wired and/or wireless communication of device data 904 with other devices. The device data 904 can include any of the various devices data and content that is generated, processed, determined, received, stored, and/or communicated from one computing device to another. Generally, the device data 904 can include any form of audio, video, image, graphics, and/or electronic data that is generated by applications executing on a device. The communication devices 902 can also include transceivers for cellular phone communication and/or for any type of network data communication.

The example device 900 can also include various, different types of data input/output (I/O) interfaces 906, such as data network interfaces that provide connection and/or communication links between the devices, data networks, and other devices. The data I/O interfaces 906 may be used to couple the device to any type of components, peripherals, and/or accessory devices, such as a computer input device that may be integrated with the example device 900. The I/O interfaces 906 may also include data input ports via which any type of data, information, media content, communications, messages, and/or inputs may be received, such as user inputs to the device, as well as any type of audio, video, image, graphics, and/or electronic data received from any content and/or data source.

The example device 900 includes a processor system 908 of one or more processors (e.g., any of microprocessors, controllers, and the like) and/or a processor and memory system implemented as a system-on-chip (SoC) that processes computer-executable instructions. The processor system 908 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 910. The example device 900 may also include any type of a system bus or other data and command transfer system that couples the various components within the device. A system bus can include any one or combination of different bus structures and architectures, as well as control and data lines.

The example device 900 also includes memory and/or memory devices 912 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 912 include volatile memory and non-volatile memory, fixed and removable media devices, and any suitable memory device or electronic data storage that maintains data for computing device access. The memory devices 912 can include various implementations of random-access memory (RAM), read-only memory (ROM), flash memory, and other types of storage media in various memory device configurations. The example device 900 may also include a mass storage media device.

The memory devices 912 (e.g., as computer-readable storage memory) provide data storage mechanisms, such as to store the device data 904, other types of information and/or electronic data, and various device applications 914 (e.g., software applications and/or modules). For example, an operating system 916 may be maintained as software instructions with a memory device 912 and executed by the processor system 908 as a software application. The device applications 914 may also include a device manager, such as any form of a control application, software application, signal-processing and control module, code that is specific to a particular device, a hardware abstraction layer for a particular device, and so on.

In this example, the device 900 includes a display manager 918 that implements various aspects of the described features and techniques described herein. The display manager 918 may be implemented with hardware components and/or in software as one of the device applications 914, such as when the example device 900 is implemented as the mobile device 102 described with reference to FIGS. 1-8. An example of the display manager 918 is the display manager 120 implemented by the mobile device 102, such as a software application and/or as hardware components in the mobile device. In implementations, the display manager 918 may include independent processing, memory, and logic components as a computing and/or electronic device integrated with the example device 900.

The example device 900 can also include a microphone 920 (e.g., to capture an audio recording) and/or camera devices 922 (e.g., to capture video images), as well as device sensors 924, such as may be implemented as components of an inertial measurement unit (IMU). The device sensors 924 may be implemented with various sensors, such as a gyroscope, an accelerometer, and/or other types of motion sensors to sense motion of the device. The device sensors 924 can generate sensor data vectors having three-dimensional parameters (e.g., rotational vectors in x, y, and z-axis coordinates) indicating location, position, acceleration, rotational speed, and/or orientation of the device. The example device 900 can also include one or more power sources 926, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 900 can also include an audio and/or video processing system 928 that generates audio data for an audio system 930 and/or generates display data for a display system 932. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 900. Alternatively, the audio system and/or the display system are external, peripheral components to the example device.

Although implementations for displaying content based on detected force on a multi-display device have been described in language specific to features and/or methods, the appended claims are not necessarily limited to the specific features or methods described. Rather, the specific features and methods are disclosed as example implementations for displaying content based on detected force on a multi-display device, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

A mobile device, including a first display device attached to a second display device, one or more proximity sensors positioned to detect one or more forces applied to the second display device, and a display manager implemented by at least one processor, the display manager configured to cause display of digital content on the first display device based at least in part on detecting the one or more forces applied to the second display device.

In some aspects, the techniques described herein relate to a mobile device, wherein the display manager is configured to detect a touch input position of an applied force on the second display device.

In some aspects, the techniques described herein relate to a mobile device, wherein the display manager maps the touch input position to the first display device.

In some aspects, the techniques described herein relate to a mobile device, wherein the digital content displayed on the first display device is based on a mirrored translation of the touch input position on the second display device.

In some aspects, the techniques described herein relate to a mobile device, wherein the display manager is configured to cause display of the digital content in response to detecting that the mobile device is unfolded, wherein the second display device is positioned opposite facing of the first display device.

In some aspects, the techniques described herein relate to a mobile device, wherein the one or more forces applied to the second display device include one or more of a swipe input, a tap input, a touch input, a hold input, or a drag input.

In some aspects, the techniques described herein relate to a mobile device, wherein the display manager is configured to detect a finger positioned proximate the second display device.

In some aspects, the techniques described herein relate to a mobile device, wherein the display manager is configured to detect whether the one or more proximity sensors are configured in a locked mode, which prevents the display manager from detecting the one or more forces applied to the second display device.

In some aspects, the techniques described herein relate to a mobile device, wherein the one or more proximity sensors use radar to detect motion relative to the second display device.

In some aspects, the techniques described herein relate to a method, including detecting one or more forces applied to one or more proximity sensors positioned relative to a second display device that is attached to a first display device of a mobile device, determining a first area of the first display device corresponding to a second area of the second display device, and causing a display change of digital content in the first area of the first display device based at least in part on detecting the one or more forces applied to the one or more proximity sensors.

In some aspects, the techniques described herein relate to a method, further including detecting a touch input position of an applied force on the second display device.

In some aspects, the techniques described herein relate to a method, further including mapping the touch input position in the second area of the second display device to the first area of the first display device.

In some aspects, the techniques described herein relate to a method, wherein the display change of the digital content in the first area of the first display device is based on a mirrored translation of the touch input position on the second display device.

In some aspects, the techniques described herein relate to a method, further including displaying the display change of the digital content in response to detecting that the mobile device is unfolded, wherein the second display device is positioned opposite facing of the first display device.

In some aspects, the techniques described herein relate to a method, wherein the one or more forces applied to the one or more proximity sensors include one or more of a swipe input, a tap input, a touch input, a hold input, or a drag input.

In some aspects, the techniques described herein relate to a method, further including detecting a finger positioned proximate the second display device.

In some aspects, the techniques described herein relate to a system, including a first display device of a mobile device attached to a second display device of the mobile device, and a display manager configured to detect a touch input from one or more forces applied to one or more proximity sensors positioned relative to the second display device, determine a first area of the first display device corresponding to a second area of the second display device, scale the touch input based on a size of the first area of the first display device relative to a size of the second area of the second display device, and cause a display change of digital content in the first area of the first display device based at least in part on the touch input.

In some aspects, the techniques described herein relate to a system, wherein the display change of the digital content displayed in the first area of the first display device is based on a mirrored translation of the touch input on the second display device.

In some aspects, the techniques described herein relate to a system, wherein the display manager is configured to cause the display change of the digital content in response to detecting that the mobile device is unfolded, wherein the second display device is positioned opposite facing of the first display device.

In some aspects, the techniques described herein relate to a system, wherein the one or more forces applied to the one or more proximity sensors include one or more of a swipe input, a tap input, a hold input, or a drag input.

1. A mobile device, comprising:
a first display device and a second display device, the second display device positioned opposite facing of the first display device in an unfolded configuration of the mobile device;
one or more proximity sensors positioned to detect one or more forces applied to the second display device in the unfolded configuration; and
a display manager implemented by at least one processor, the display manager configured to:
determine input coordinates on the second display device that correspond to the one or more forces applied to the second display device;
identify mirrored coordinates on the first display device that correspond to the input coordinates on the second display device; and
cause display of digital content on the first display device at the mirrored coordinates on the first display device based at least in part on the one or more forces applied to the second display device.

2. The mobile device of claim 1, wherein the display manager is configured to detect a touch input position of an applied force on the second display device to determine the input coordinates on the second display device.

3. The mobile device of claim 2, wherein the display manager maps the touch input position to the first display device.

4. The mobile device of claim 2, wherein the digital content displayed on the first display device is based on a mirrored translation of the touch input position on the second display device.

5. (canceled)

6. The mobile device of claim 1, wherein the one or more forces applied to the second display device include one or more of a swipe input, a tap input, a touch input, a hold input, or a drag input.

7. The mobile device of claim 1, wherein the display manager is configured to detect a finger positioned proximate the second display device.

8. The mobile device of claim 1, wherein the display manager is configured to lock the one or more proximity sensors based on receiving an input specifying that the one or more proximity sensors are configured in a locked mode, which prevents the display manager from detecting the one or more forces applied to the second display device.

9. The mobile device of claim 1, wherein the one or more proximity sensors use radar to detect motion relative to the second display device.

10. A method, comprising:
detecting one or more forces applied to one or more proximity sensors positioned relative to a second display device that is attached to a first display device of a mobile device, the second display device positioned opposite facing of the first display device in an unfolded configuration of the mobile device;
determine input coordinates on the second display device that correspond to the one or more forces applied to the second display device;
identify mirrored coordinates of the first display device that correspond to the input coordinates of the second display device; and
causing a display change of digital content at the first display device at the mirrored coordinates on the first display device based at least in part on detecting the one or more forces applied to the one or more proximity sensors.

11. The method of claim 10, further comprising detecting a touch input position of an applied force on the second display device to determine the input coordinates on the second display device.

12. The method of claim 11, further comprising mapping the touch input position in a second area of the second display device to a first area of the first display device to identify the mirrored coordinates.

13. The method of claim 11, wherein the display change of the digital content at the first display device is based on a mirrored translation of the touch input position on the second display device.

14. (canceled)

15. The method of claim 10, wherein the one or more forces applied to the one or more proximity sensors include one or more of a swipe input, a tap input, a touch input, a hold input, or a drag input.

16. The method of claim 10, further comprising detecting a finger positioned proximate the second display device.

17. A system, comprising:
a first display device of a mobile device and a second display device of the mobile device, the second display device positioned opposite facing of the first display device in an unfolded configuration of the mobile device; and
a display manager configured to:
detect a touch input from one or more forces applied to one or more proximity sensors positioned relative to the second display device in the unfolded configuration;
determine input coordinates of a second area of the second display device that correspond to the one or more forces applied to the second display device;
identify mirrored coordinates of a first area of the first display device that correspond to the input coordinates on the second display device;
scale the touch input based on a size of the first area of the first display device relative to a size of the second area of the second display device; and
cause a display change of digital content in the first area of the first display device at the mirrored coordinates on the first display device based at least in part on the touch input.

18. The system of claim 17, wherein the display change of the digital content displayed in the first area of the first display device is based on a mirrored translation of the touch input on the second display device.

19. (canceled)

20. The system of claim 17, wherein the one or more forces applied to the one or more proximity sensors include one or more of a swipe input, a tap input, a hold input, or a drag input.

21. The method of claim 10, further comprising detecting whether the one or more proximity sensors are configured in a locked mode, which prevents detecting the one or more forces applied to the second display device.

22. The method of claim 10, wherein the one or more proximity sensors use radar to detect motion relative to the second display device.

23. The mobile device of claim 1, wherein the display manager is configured to display an indication on the first display device that corresponds to the one or more forces applied to the second display device.
